(19) United States
(12) Patent Application Publication
(10) Pub. No.: US 2023/0079739 A1
(43) Pub. Date: Mar. 16, 2023

(54) DEBONDABLE PRESSURE SENSITIVE ADHESIVES AND USES THEREOF

(71) Applicant: Henkel AG & CO, KGaA, Dusseldorf (DE)

(72) Inventors: Peter Walter, Hampton, NJ (US); James Nowicki, Hopewell, NJ (US)

(21) Appl. No.: 17/817,739

(22) Filed: Aug. 5, 2022

Related U.S. Application Data
(63) Continuation of application No. PCT/US2021/016709, filed on Feb. 5, 2021.
(60) Provisional application No. 62/972,681, filed on Feb. 11, 2020.

(51) Int. Cl. C09J 133/08; C09J 4/06; C09J 5/00; B32B 27/08; B32B 7/12; B32B 7/06; B32B 43/00; B32B 27/36; B32B 27/32

(52) U.S. Cl. CPC C09J 133/08; C09J 4/06; C09J 5/00; B32B 27/08; B32B 7/12; B32B 7/06; B32B 43/006; B32B 27/36; B32B 27/32; C09J 2433/00; C09J 2301/302; C09J 2301/416; C09J 2301/502; B32B 2367/00; B32B 2323/10; B32B 2250/02; B32B 2255/10; B32B 2255/26; B32B 2307/748; B32B 2310/0831

(57) ABSTRACT

The invention relates to on-demand debondable pressure sensitive adhesive and laminating adhesive compositions and uses thereof. The debondable pressure sensitive adhesives and laminating adhesives are applied onto a substrate to form a bond, and upon exposure to electron beam or UV light energy source, the adhesive can dissociate from the substrate. The debondable pressure sensitive adhesives and laminating adhesives are particularly suitable for recycling in a circular economy.

### FIELD OF THE INVENTION

The invention relates to on-demand debondable pressure sensitive adhesive compositions and uses thereof. The debondable pressure sensitive adhesives are particularly suitable for recycling substrates in a circular economy.

### BACKGROUND OF THE INVENTION

More than 40% of plastic is used only once, then discarded. Better recyclability can increase multiple uses for plastic, thereby decreasing landfill and pollution. Labels and laminates are typically applied onto plastic substrates with adhesives. Pressure sensitive adhesives and laminating adhesives retain their adhesive characteristics that make them difficult for recycling. Tackiness and rubbery properties in the pressure sensitive adhesives prevent substrates to be separated and recycled. In order to detach or separate layers from one another, dissolution and reprecipitation techniques are widely used with recycling machinery; however, this can lead to “gumming” of the machinery. Very strong bonds for laminating adhesives prevent substrate separation, and thus, many laminates end up in landfills.

To facilitate detachment of the adhesive from the substrate or separation of multilayered substrates, U.S. Pat. Nos. 7,901,532 and 5,609,954 disclose the use of microspheres for quick release and detachment, but initial adhesive strength is too weak for many applications. Some processes, particularly for wafer bonding, utilize very high temperature, higher than the melting point of many plastics, and would result in undesirable shrinkage, distortion, chemical degradation, or oxidation, making these processes unsuitable for plastics. Another process, U.S. Pat. No. 9,565,773, teaches to first cure using one type of chemistry, and then debond with another chemistry, adding complexity.

Therefore, there is a need in the art for a triggerable, on-demand, debonding adhesives to become non-tacky and aid in removal from substrates for the purpose of recycling. The current invention fulfills this need.

### BRIEF SUMMARY OF THE INVENTION

The invention provides debondable pressure sensitive adhesive compositions, uses, and articles comprising the same. The debondable pressure sensitive adhesives are made so that upon activation, the debondable pressure sensitive adhesives become substantially non-tacky and readily debond from the attached substrate, making it suitable in recycling systems.

Typical pressure sensitive adhesives, when coated and dried onto a surface, exhibit significant residual surface tack, surface wetting, and adhesion; which allow for the adhesives to readily bond to a broad range of substrates with minimum applied pressure and without need for applied heat. Certain pressure sensitive adhesives and laminating adhesives are used to adhere multiple layers of substrates. The very strong bonds of the laminating adhesives prevent delamination of substrate layers from the laminate. On-demand debonding these adhesives, therefore, is difficult to achieve for pressure sensitive and laminating adhesives. The current invention is directed to on-demand debonding pressure sensitive and laminating adhesives to allow for easy separation and recycling without utilizing dissolution and reprecipitation techniques.

In one embodiment, the invention is directed to a debondable pressure sensitive adhesive comprising:
i. an acrylic oligomer or oligomers having
   a. a viscosity range of at least 300 cps to about 8,000 cps measured by ASTM D4402 at 60° C. with spindle #27 at 20 rpms; and
   b. at least two acrylate functional groups, and
ii. at least one polymer having a solubility parameter range greater than about 8 to less than about 15;
where the residual strength ratio of debondable pressure sensitive adhesive is less than 0.10.

Another embodiment of the invention is directed to an article comprising a substrate attached to a debondable adhesive comprising:
a. an acrylic oligomer having (i) a viscosity range of at least 300 cps to about 8,000 cps measured by ASTM D4402 at 60° C.; and (ii) at least two acrylate functional groups, and
b. at least one polymer having a solubility parameter range greater than about 8 to less than about 15;
   where the residual strength ratio of debondable pressure sensitive adhesive is less than 0.10.

Yet another aspect of the invention is directed to a method of debonding an article, wherein the article comprises a substrate having a first surface and a second surface, and a debondable pressure sensitive adhesive coated onto the first surface of the substrate comprising the steps of:
a. preparing the article;
b. applying an electron beam or a UV light to the article, whereby the debondable adhesive becomes substantially non-tacky; and
c. optionally, agitating the debondable adhesive or the substrate, whereby the debondable adhesive and the substrate separates from each other.
   The debondable adhesive has (1) an acrylic oligomer having (i) a viscosity range of at least 300 cps to about 8,000 cps measured by ASTM D4402 at 60° C.; and (ii) at least two acrylate functional groups, and (2) at least one polymer having a solubility parameter range greater than about 8 to less than about 15; and (3) a residual strength ratio of less than about 0.10.

A further embodiment of the invention is directed to a method of debonding a laminate, wherein the laminate comprises a first substrate having a first surface and a second surface, a second substrate having a first surface and a second surface, and a debondable adhesive coated and joining the first surface of the first substrate and second surface of the second substrate, comprising the steps of:
a. preparing the article;
b. applying an electron beam or a UV light to the laminate; whereby the debondable adhesive becomes substantially non-tacky; and
c. optionally, agitating at least one substrate, whereby the at least one substrate separates the from the debondable adhesive or the laminate;
   The debondable adhesive has (1) an acrylic oligomer having (i) a viscosity range of at least 300 cps to about 8,000 cps measured by ASTM D4402 at 60° C., and (ii) a at least two acrylate functional groups; and (2) at least one polymer having a solubility parameter range greater than about 8 to less than about 15; and (3) a residual strength ratio of less than about 0.10.

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

The articles “a” and “an,” as used herein, mean one or more when applied to any aspects of the present disclosure. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

As used herein, an oligomer is a macromolecule that consists of monomer units is equal or greater than about two monomer units.

As used herein, an adherend or substrate, used interchangeably, are part of an article where an adhesive is applied onto one substrate to attach onto yet another substrate, thereby sandwiching the adhesive in between the two adherends. Each substrate, independently, may be paper, plastic, metal, fiber, wood, film, carpet, glass, rubber, composite, crystal, mineral or foam. The adhesive is used to attached one substrate to another similar or dissimilar substrate.

As used herein, a pressure sensitive adhesive is an adhesive that forms a bond when pressure is applied to marry the adhesive with the adherend. No solvent, water, or heat is necessary to activate the adhesive to form the bond with the adherend. The laminating adhesive provides strong adhesion to join similar to dissimilar substrates together in a laminate. The adhesive, pressure sensitive adhesive and laminating adhesive, are formed as a single-phase, homogeneous, compatible state. Each adhesive should be homogenous and should remain in a single phase during application and storage. Applying phase separated adhesive onto substrates can lead to inconsistent and poor adhesion. Suitable homogeneous mixtures also includes pressure sensitive adhesives and laminating adhesives that contain block polymer structures having micro-domains, and also filled mixtures so long as those domains and mixtures do not separate during application or storage.

Typical pressure sensitive adhesives remain permanently tacky and have the ability to wet surfaces on contact with minimum applied pressure. A debondable pressure sensitive adhesive can be activated or triggered to become substantially non-tacky. In this substantially non-tacky state, the adhesive may be recycled, as is, along with its substrate if it is less than about 10% by weight of the article. The adhesive may also be separated and allows the adherends to separate from the adhesive without difficulty such that the adherends can be repositioned or recycled.

On-demand debonding of the pressure sensitive or laminating adhesives is conducted by exposing the adhesives to energy such as electron beam or UV light. This type of debonding does not require solvent or caustic exposure of the article. Separation of the substrates can be accomplished with low mechanical efforts, which are already known in the art, e.g., roller brush. It is particularly desirable to debond adherends for end of life articles, allowing easy recycling of the adherends. Depending on the application needs and constrains, debonding source must fit the needs of the substrate requirements, e.g., low heat for plastic substrates, and should be environmentally friendly, cost effective, and should leave minimal to no adhesive residue on the substrate.

Bond strength measures the absolute tackiness and adhesiveness of the debondable adhesive. Thus, the higher the value of the bond strength, the stronger the adhesion of the adhesive onto a specific substrate, and vice versa. The relative debondableness or the residual strength ratio (i), herein, is determined by a residual strength ratio of the adhesive at its initial strength and after activation to form it into a non-tacky form.

The residual strength ratio is defined as:

$$\frac{bond strength of cured debondable pressure sensitive adhesive}{bond strength of uncured debondable pressure sensitive adhesive} \qquad ( i )$$

The bond strength is measured with ASTM D903 run at a peel rate of 12″/min. It is desirable to have the residual strength ratio to be less than about 0.10. Substantially non-tacky, herein, means that the bond strength of the cured debondable adhesive is less than about 10% of the bond strength of the uncured debondable adhesive. Thus, for adhesive having very high initial bond strength may still have some absolute bond strength after activation; however, its relative ratio should be less than 0.10 to aid in recyclability. Ratio greater than about 0.10 provides undesirable resistance to separate from the substrate(s).

In one embodiment, the invention is directed to a debondable pressure sensitive adhesive comprising:
i. an acrylic oligomer or oligomers having
   (a) a viscosity range of at least 300 cps to about 8000 cps, as measured by ASTM D4402 at 60° C.; and
   (b) at least two acrylate functional groups; and
ii. at least one polymer having a solubility parameter range greater than about 8 to less than 15;
   where the residual strength ratio of debondable pressure sensitive adhesive is less than 0.10.

The viscosity range of the acrylic oligomer is such that it allows adhesive to form a strong, initial green strength to a substrate. Acrylic oligomers with viscosity range greater than about 8000 cps, as measured by ASTM D4402 at 60° C., typically fail to provide initial tack desired for a pressure sensitive adhesive when combined with a polymer suitable for the invention. The acrylic oligomer can additionally include chemical linkages of epoxy, urethane, ester, ether, amide, and combination thereof. Acrylate functional groups greater than or equal to two on the acrylic oligomer provides cure for the adhesive upon activiation, and in turn, allows the adhesive to readily debond from substrates. Monofunctional acrylate oligomers within the viscosity range described fail to provide enough cure in order to readily debond from substrates.

Suitable acrylic oligomer includes epoxy di or tri-acrylates (e.g., Sartomer CN 120Z or Genomer 2312), urethane di or tri or tetra-acrylates (e.g., Sartomer CN9167US, Genomer 4312 or Genomer 4425), and polyester di or tri or tetra-acrylates (e.g., Ebecryl 5849, Ebecryl 885 or Ebecryl 889) are particularly suitable as the acrylic oligomer in the debondable pressure sensitive adhesive.

The debondable pressure sensitive adhesive further includes a polymer having a solubility parameter range greater than about 8 to about less than about 15. Particularly, the polymer has a solubility parameter range greater than 8.2 to less than 14.6. While not bound to a specific scientific theory, it is believed that a polymer having a solubility parameter range greater than 8.2 to less than 14.6 allows for adhesive to be compatible and less likely to phase separate during and after application onto a substrate. Furthermore, the compatibility of the polymer with the acrylic oligomer enable the polymer to provide strength and reinforcement to the compatible pressure sensitive adhesive.

Solubility parameter (6) is a unitless value based on Hildebrand and Hansen solubility parameters that provides a guideline of polymer solubility in solvent. The closer the solubility parameter of the polymer and solvent, the more likely the polymer will dissolve in the given solvent. Many polymers, oligomers, and solvent solubility parameters are well known and may be found in various references including Signa Aldrich, CRC Handbook of Chemistry and Physics, Merck Index, and the like. For others, it can be estimated by calculating Hildebrand or Hansen solubility parameters. It can also be experimentally determined by dissolving one or more grams of solute into 100 ml of various known solvents, and the range at which it dissolves is the solute's solubility range.

Suitable polymers include polyester (e.g., Skybon ES 215 or Dynapol L323), polyurethane, polyether, polyacrylic (e.g., Kurarity LA2330 or Elvacite 2967), polyvinyl acetate, polyethylene vinylacetate copolymers (e.g., Levapren 450 or Levamelt 800), polyvinyl alcohol, and polyamide (e.g., Unirez 2224 or Ancatherm 592).

The debondable adhesive composition may further comprise a photoinitiator, amine, amine acrylate adduct, tackifier, a solvent, a wax, an antioxidant, and mixtures thereof.

Another embodiment of the invention is directed to an article comprising a first substrate bonded to a debondable adhesive comprising:
a. an acrylic oligomer having (i) a viscosity range of at least 300 cps to about 8,000 cps measured by ASTM D4402 at 60° C.; and (ii) at least two acrylate functional groups, and
b. at least one polymer having a solubility parameter range about 8 to less than about 15;
   where the residual strength ratio of debondable adhesive is less than 0.10.

The substrate may be paper, fiber, Kraft paper, wood, metal, film, carpet, glass, rubber, composite, crystal, mineral or foam.

Yet another aspect of the invention is directed to a method of debonding an article, wherein the article comprises a substrate having a first surface and a second surface, and a debondable adhesive coated and bonded onto the first surface of the substrate, comprising the steps of:
a. preparing the article;
b. applying an electron beam or a UV light to the article, whereby the debondable adhesive becomes substantially non-tacky; and
c. optionally, agitating the debondable adhesive or the substrate, whereby the debondable adhesive and the substrate dissociates from each other.
   The debondable adhesive has (1) an acrylic oligomer having (i) a viscosity range of at least 300 cps to about 8,000 cps measured by ASTM D4402 at 60° C.; and (ii) at least two acrylate functional groups, and (2) at least one polymer having a solubility parameter range greater than about 8 to less than about 15; and (3) a residual strength ratio of less than about 0.10.

The electron beam or the UV light may also be selectively applied onto a portion of the article, only to the debondable adhesive or to the second surface of the first substrate. The electron beam or the UV light can transmit through the first or second substrate and activate the debondable adhesive located beneath the first substrate.

The on-demand debonding can be achieved by exposing the debondable adhesive to an energy source of electron beam or a UV light. This provides the residual strength ratio to become less than about 0.10. Agitating the substrate or the substantially non-tacky adhesive separates the various layers, e.g., substrate or debondable adhesive, from the article to aid in recycling. In another embodiment, the entire article, including the substantially non-tacky adhesive, may be recycled in its entirety if the non-tacky adhesive is less than about 10 wt %, preferably less than 5 wt %, of the article.

A further embodiment of the invention is directed to a method of debonding a laminate, wherein the laminate comprises a first substrate having a first surface and a second surface, a second substrate having a first surface and a second surface, and a debondable adhesive coated and bonded the first surface of the first substrate and second surface of the second substrate, comprising the steps of:
a. preparing the article;
b. applying an electron beam or a UV light to the laminate;
c. agitating at least one substrate, whereby the at least one substrate separates from the laminate.
   The debondable has (1) an acrylic oligomer having (i) a viscosity range of at least 300 cps to about 8,000 cps measured by ASTM D4402 at 60° C., and (ii) at least two acrylate functional groups; and (2) at least one polymer having a solubility parameter range greater than about 8 to less than about 15; and (3) a residual strength ratio of less than about 0.10.

The energy source can travel through a substrate or multiple layers of substrates and debond adhesives embedded in between the substrate layers, thereby allowing each substrate layer to be separated. The on-demand debonding can also be achieved by exposing an energy source of electron beam or a UV light directly onto one layer or a portion of the laminate.

### EXAMPLES

The following examples are provided for illustrative purposes only, without wishing to subject them to any unnecessary restriction.

Solvent containing samples were prepared by combining the components of the formulation at 75° C. until the mixture became homogeneous, then cooling to ambient temperature before testing. Solvent free samples were prepared by combining the components of the formulation at 130° C. until the mixture became homogeneous.

Viscosity was measured by Brookfield viscometer, Spindle RV-4, 20 or 50 rpm at 25° C.

Bond tests were conducted using typical methods known to individuals skilled in the art and are described in further details below.

Test samples were made by hand coating each solvent containing adhesive with a #20 meyer rod onto 75 gauge corona treated oriented polypropylene (OPP) film. Coated films were dried in an oven at 85° C. for 2 minutes to deliver approximately 6 grams/meter² of a dried adhesive coating. Test samples made from solvent free adhesives were coated onto release paper using a heated bar at 150° C. having a controlled gap so as to deliver a 0.001″ coating. The solvent free coating was then transferred to the OPP film and release paper was removed so that the coated film could be tested. No drying was required for the solvent free samples.

Bond Strength Before Cure was measured by first laminating coated OPP film to 48 gauge corona treated polyester film (PET) using a cold seal press at 60 psi pressure for 2 seconds. Laminations are not exposed to an energy source. Laminations were cut into 1 inch wide test strips. Laminated test strips were pulled apart by a laboratory extensionometer at ambient temperature a rate of 12 inches per minute and the force to peel the adhesive laminations apart was recorded in grams force per inch (gli).

Cured Coating Strength was measured by first exposing the tacky OPP coated films to the energy source (electron beam or UV light), then taking the resulting cured non-tacky coating on OPP and laminating it to 48 gauge corona treated polyester film (PET) using a cold seal press at 60 psi pressure for 2 seconds. Laminations were cut into 1 inch wide test strips. Laminated test strips were pulled apart by a laboratory extensionometer at ambient temperature at a rate of 12 inches per minute and the force to peel the adhesive laminations apart was recorded as Cured Coating Strength.

The electron beam energy source and conditions used for cure were typical for what is known to individuals skilled in the art. Electron beam cure conditions were used at a dose of 3 mRad at 125 KeV and a sample tray speed of 75 feet/min with nitrogen inerting below 200 ppm oxygen.

The UV energy source and conditions used for cure were typical for what is known to individuals skilled in the art. UV light was used at a dose of 200 mJ at a belt speed of 50 feet/min using a D style UV bulb without nitrogen inerting.

Residual Strength Ratio (ii) was calculated by dividing the resulting Cured Coating Strength by the PSA Bond Strength Before Cure.

$$\frac{Cured Coating Strength}{Bond Strength Before Cure} = Residual Strength Ratio \qquad ( ii )$$

Cured Lamination Strength was measured by first laminating coated OPP film to 48 gauge corona treated polyester film (PET) using a cold seal press at 60 psi pressure for 2 seconds. Laminations were next exposed to the energy source (electron beam or UV light). Laminations were cut into 1 inch wide test strips and pulled apart by a laboratory extensionometer at ambient temperature a rate of 12 inches per minute. The force to peel these adhesive laminations apart was recorded as Cured Lamination Strength.

Residual Lamination Strength Ratio (iii) was calculated by dividing the resulting Cured Lamination Strength by the PSA Bond Strength Before Cure.

$$\frac{Cured Lamination Strength}{Bond Strength Before Cure} = Residual Lamination Strength Ratio \qquad ( iii )$$

Typical industrial curing conditions were used for testing. For electron beam the curing conditions were 3 MRad dose, 125 KeV, at 75 feet/min with less than 200 ppm oxygen. Curing conditions for UV light were approximately 200 mJ dose at 50 feet/min using a D style UV bulb without nitrogen inerting.

### Example 1. Comparative Samples

Comparative samples CE1, CE2, and CE3 are detailed in Table 1.

TABLE 1
Comparative Examples

| Components | CE1 | CE2 | CE3 |
|---|---|---|---|
| Ethanox 310 antioxidant | 0.6 | | |
| Wingtack 10 | 30.3 | | |
| Sylvalite RE 85 GB | 17.3 | | |
| Calsol 5550 | 18.5 | | |
| Vector 4211 A (SIS Rubber) | 13.3 | | |
| Vector 4114 A (SIS Rubber) | 20.0 | | |
| Butyl Acrylate | | | 49.9 |
| Acrylic Acid | | | 3.4 |
| Azo bis isobutyronitrile | | | 0.2 |
| 4-(methacryloyloxy)benzophenone | | | 0.1 |
| Ethyl Acetate | | 45.0 | 46.4 |
| Wingtack 10 | | 6.0 | |
| Sylvalite RE 40 | | 8.0 | |
| Levamelt 800 EVA Copolymer | | 11.0 | |
| Toluene | | 30.0 | |
| Bond Strength | | | |
| Bond Strength Before Cure (gli) | 159 | 149 | 1783 |
| Cured Coating Strength (gli) | 128 | 149 | 1636 |
| Cured Lamination Strength (gli) | 150 | 141 | N/A |
| Residual Strength Ratio: | 0.805 | 1.00 | 0.918 |
| Residual Lamination Strength | 0.943 | 0.946 | N/A |
| Ratio: | | | |

Both hot melt (CE1 and CE2) and solvent-based (CE3) pressure sensitive adhesives were prepared and tested for residual ratios. Comparative examples had ratios of greater than 0.8, indicating that the cured materials still had significant tackiness. Such adhesives would provide gumminess during recycling process and would prevent easy separation of the adhesive from the substrate.

### Example 2. On-Demand Debondable Adhesives

Table 2 details the components to the inventive, on-demand, debondable adhesives. As shown, Examples 4-8 provide residual strength ratio of less than about 0.1. This indicates that the substrates debond readily from the article or delaminate from the other substrate layers.

TABLE 2
On-demand Debondable Adhesives

| Components | Ex 4 | Ex 5 | Ex 6 | Ex 7 | Ex 8 |
|---|---|---|---|---|---|
| Sylvatac RE 40 | 5.5 | | | | |
| Levapren 450 | 8.25 | | | | |
| (45% VA, 20 Ml) | | | | | |
| Levamelt 800 | | 10 | 10 | | |
| (80% VA, 4 Ml) | | | | | |
| Skybon ES 215 | | | | 12.0 | |
| Polyester Polymer | | | | | |
| Kurarity LA2330 | | | | | 15.4 |
| Acrylic Polymer | | | | | |
| EtoAc | 45 | 75 | 75 | 75 | 65 |
| TPO | | | 1 | | |
| Photomer 4250 | | | 3 | | |
| Toluene | 30 | | | | |
| Genomer 4425 | | 3 | | | |
| Sartomer CN 120Z | 11.25 | 12 | 11 | 13 | 19.6 |
| Brookfield Viscosity | | 87.4 | 87.8 | 21.6 | 65.6 |
| (cps) | | | | | |
| Coating Weight (g/m²) | | 6.22 | | | |
| Bond Strength Before | 284 | 290 | 251 | 435 | 496 |
| Cure (gli) | | | | | |
| Cured Coating | 5 | 0 | 0 | 1.8 | 5 |
| Strength (gli) | | | | | |
| Cured Lamination | | 3.6 | 5.9 | 8.2 | 7.3 |
| Strength (gli) | | | | | |
| Residual Strength Ratio | 0.018 | 0 | 0 | 0.004 | 0.01 |
| Residual Lamination | | 0.012 | 0.024 | 0.019 | 0.015 |
| Strength Ratio | | | | | |

Residual strength ratios and residual lamination strength ratios are below 0.1 for Examples 4-8. This indicates that the substrates debond readily from the article or delaminates from other substrate layers, and thus, they are suitable for recycling processes.

Examples 4 and 5 are pressure sensitive adhesive made with acrylic oligomer and vinyl acetate polymer with varying vinyl acetate contents. Upon exposure to electron beam energy, they readily de-bond, as demonstrated in the residual strength ratio and residual lamination strength ratio of Table 2. Optional tackifiers may be added to improve adhesiveness to various substrates as shown in Example 4. Addition of a multifunctional acrylate maintains or increases bond strength, while further lowering the debond force as shown by the lower residual strength ratio in Example 5.

Example 6 is formed with an acrylic oligomer, a polymer, and a photoinitiator. Upon exposure to ultraviolet light (UV) energy, it de-bonds easily as demonstrated in low ratios. Both a photoinitiator and a multifunctional amine acrylate (Photomer 4250) are added to make the formulation responsive to UV energy and to prevent oxygen inhibition.

Example 7 utilizes polar polyester with acrylic oligomer.

Example 8 utilizes acrylic polymer with acrylic oligomer.

### Example 3. Acrylic Oligomers

Various acrylic oligomers, with specific number of functionalities and viscosities at 60° C. are listed in Table 3.

TABLE 3
Various Acrylic Oligomers

| Acrylic | # of functional | Viscosity 60° C. |
|---|---|---|
| Oligomer | groups | (cps) |
| Genomer 4425 | 4 | 300 |
| CN9167US | 2 | 700 |
| CN 120Z | 2 | 2,700 |
| CN996H90 | 1 | 8,000 |

The above acrylic oligomers were then tested as on-demand debondable adhesive, and the residual strength ratios and residual lamination strength ratios were measured in Table 4.

TABLE 4
Effect of Acrylic Oligomers

| Components | Ex A | Ex B | Ex C | Ex D |
|---|---|---|---|---|
| Levamelt 800 (80% VA, 4 Ml) | 15.50 | 15.50 | 15.50 | 15.50 |
| EtoAc | 65.00 | 65.00 | 65.00 | 65.00 |
| Genomer 4425 | 0.00 | 0.00 | 0.00 | 19.50 |
| Sartomer CN9167US | 0.00 | 0.00 | 19.50 | 0.00 |
| Sartomer CN966H90 | 0.00 | 19.50 | 0.00 | 0.00 |
| Sartomer CN 120Z | 19.50 | 0.00 | 0.00 | 0.00 |
| Brookfield Viscosity (cps) | 675 | 758.4 | 511.9 | 426.6 |
| PSA Bond Strength (gli) | 484 | 318 | 374 | 207 |
| Cured Coating Strength (gli) | 1.4 | 96 | 5.0 | 2.3 |
| Cured Lamination Strength (gli) | 5.0 | 140 | 8.6 | 5.4 |
| Residual Strength Ratio | 0.003 | 0.302 | 0.013 | 0.011 |
| Residual Lamination | 0.010 | 0.440 | 0.023 | 0.026 |
| Strength Ratio | | | | |

Acrylic oligomers having at least two functional groups and a viscosity range less than about 8,000 cps (at 60° C.), when coupled with a polymer having a solubility parameter of from about 8 to about 15, provide suitable debondable adhesives. Example B contains a monofunctional acrylate oligomer with a high viscosity and provides higher ratios than 0.1, and as such, does not provide the desired effect of on-demand debonding.

Table 5 lists solubility parameters of the polymers as found in literature references. Various acrylic oligomers were tested in known solvents to determine the range of polymer solubility parameters suitable for compatibility in Table 6. The solubility parameters range of each acrylic oligomer was experimentally determined based on its solubility in known solvents. Five grams of the acrylic oligomer was dissolved in 100 ml of the solvent to determine compatibility (soluble, turbid or insoluble).

TABLE 5
Polymer Solubility Parameters

| Polymer¹ | Solubility Parameter (δ) |
|---|---|
| Polyisobutylene | 7.8 |
| Polyethylene | 8.0 |
| 1,4-cis-Polyisoprene | 8.0 |
| Polyisoprene, natural rubber | 8.2 |
| Polypropylene³ | 8.2 |
| Polystyrene | 8.7 |
| Polyurethane³ | 8.9 |
| Polyethylene vinylacetate (40% VA)⁴ | 8.9 |
| Polybutyl acrylate | 9.0 |
| PMMA³ | 9.3 |
| Polyethyl acrylate | 9.5 |
| Polyvinyl chloride | 9.5 |
| Polyvinyl acetate | 10.0 |
| PET³ | 10.1 |
| Polyvinyl alcohol | 12.6 |
| Polyamide (Nylon 6/6) | 13.6 |
| Cellulose | 15.6 |

¹http://www.sigmaaldrich.com/content/dam/sigma-aldrich/docs/Aldrich/General_Information/polymer_solutions.pdf
2. http://www.cool.conservation-us.org/coolaic/sg/bpg/annual/v03/bp03-04.html
³https://en.wikipedia.org/wiki/Hildebrand_solubility_parameter
⁴Based on an average estimation for solubility parameters of solvents identified for Elvax 40W in the Eastman Chemical Resin Solubility Chart RES-001

TABLE 6
Solubility Determination of Oligomers using Known Solvents

| | Solubility | Sartomer | Sartomer | Rahn | Sartomer |
|---|---|---|---|---|---|
| Solvent¹ | Parameter (δ) | CN120Z | CN9167US | Genomer 4425 | CN966H90 |
| Cyclohexane | 8.2 | Insoluble | Insoluble | Insoluble | Insoluble |
| Butyl Acetate | 8.3 | Soluble | Soluble | Soluble | Soluble |
| Ethyl Acetate | 9.1 | Soluble | Soluble | Soluble | Soluble |
| Dipropylene | 10.0 | Soluble | Soluble | Soluble | Turbid |
| Glycol | | | | | |
| Butyl Alcohol | 11.4 | Soluble | Turbid | Turbid | Turbid |
| Propylene | 12.6 | Soluble | Turbid | Turbid | Insoluble |
| Glycol | | | | | |
| Methanol | 14.5 | Soluble | Turbid | | |
| Ethylene Glycol | 14.6 | Turbid | | | |

¹http://www.sigmaaldrich.com/content/dam/sigma-aldrich/docs/Aldrich/General_Information/polymer_solutions.pdf

Based on the above experiments, the solubility of Sartomer CN120Z ranges from 8.3 to 14.5, Sartomer CN9167US and Rahn Genomer 4425 range from 8.3 to 10.0, and CN966H90 ranges from 8.3 to 9.1.

The effects of the polymer solubility was tested and the results are shown in Table 7.

TABLE 7
Effect of Polymer Solubility Parameter

| Components | Ex E | Ex F | Ex G |
|---|---|---|---|
| Vector 4211 A; SIS Rubber | 4.00 | | |
| (Est δ 8.0) | | | |
| Vector 4114 A; SIS Rubber | 8.00 | | |
| (Est δ 8.0) | | | |
| Uni-Rez 2224; polyamide | | 12.00 | |
| (Est δ 13.6) | | | |
| Methocel K100LV; cellulose | | | 6.00 |
| (Est δ 15.6) | | | |
| Butyl Acetate | 75.00 | | |
| EtoAc | | | |
| Ethanol | | 75.00 | 81.00 |
| Sartomer CN 120Z | 13.00 | 13.00 | 13.00 |
| miscibility | incompatible | compatible | incompatible |
| Coated OPP Pressed to PET | | | |
| (2 s, 60 psi, RT): | | | |
| PSA Bond Strength (gli): | X | 25.4 | X |
| Cured Coating Strength (gli): | X | 0.9 | X |
| Cured Lamination | X | 1.6 | X |
| Strength (gli): | | | |
| Residual Strength Ratio: | X | 0.035 | X |
| Residual Lamination | X | 0.063 | X |
| Strength Ratio: | | | |

As shown in Table 7, polymers having a solubility range of greater than about 8, but less than about 15 provide to be suitable for on-demand adhesive. Outside of those solubility parameter ranges, the adhesives fail to form a compatible, single-phase system.

### Example 5. High Strength, On-Demand Laminating Adhesives

For certain applications, high initial bond strength is required, but on-demand debonding is still desirable. The initial bond strength may be controlled by the selection of the acrylic oligomer. As demonstrated in Table 8, for such applications, a careful selection of acrylic oligomer can provide high initial strength. Very high initial bond adhesives were prepared in Table 8, which are ideally suited as laminating adhesives. Solvent-free adhesives may also be prepared by modifying the components (Ex Z).

TABLE 8
High Strength Laminating Adhesives

| Components | Ex X | Ex Y | Ex Z |
|---|---|---|---|
| Skybon ES 215 | 21.00 | 21.00 | 21.00 |
| Photomer 4250 | 0.00 | 3.00 | 0.00 |
| TPO | 0.00 | 1.00 | 0.00 |
| EtoAc | 65.00 | 65.00 | 0.00 |
| Sartomer CN 120Z | 14.00 | 10.00 | 14.00 |
| Brookfield Viscosity (cps) | 55.5 | 81 | |
| Coating height (mil) | | | 1 |
| PSA Bond Strength (gli) | 749 | 642 | 1607 |
| Cured Coating Strength (gli) | 2.7 | 1.4 | 5.4 |
| Cured Lamination Strength (gli) | 16.3 | 15.4 | 9.1 |
| Residual Strength Ratio | 0.004 | 0.002 | 0.003 |
| Residual Lamination Strength Ratio | 0.022 | 0.024 | 0.006 |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A debondable pressure sensitive adhesive comprising:
i. an acrylic oligomer or oligomers having
a. a viscosity range of at least 300 cps to about 8,000 cps measured by ASTM D4402 at 60° C.; and
b. at least two acrylate functional groups, and
ii. at least one polymer having a solubility parameter range greater than about 8 to less than about 15;
wherein the residual strength ratio of debondable pressure sensitive adhesive is less than 0.10, measured as:
$$\frac{bond strength of cured debondable pressure sensitive adhesive}{bond strength of uncured debondable pressure sensitive adhesive}$$
wherein the bond strength is measured with ASTM D903.

2. The debondable pressure sensitive adhesive of claim 1, wherein the acrylic oligomer further comprises a functionality of epoxy, urethane, ester, ether, amide or combination thereof.

3. The debondable pressure sensitive adhesive of claim 1, wherein the polymer is selected from the group consisting of ethylene vinyl acetate copolymer, polyester polymer, acrylic polymer, and mixtures thereof.

4. The debondable pressure sensitive adhesive of claim 1, further comprising (iii) a tackifier, a solvent, a wax, an antioxidant, and mixtures thereof.

5. The debondable pressure sensitive adhesive of claim 1, further comprising (iv) a photoinitiator, amine, amine acrylate adduct, and mixtures thereof.

6. An article comprising a first substrate bonded to a debondable adhesive comprising:
a. an acrylic oligomer having (i) a viscosity range of at least 300 cps to about 8,000 cps measured by ASTM D4402 at 60° C.; and (ii) at least two acrylate functional groups, and
b. at least one polymer having a solubility parameter range greater than about 8 to less than about 15;
wherein the residual strength ratio of debondable adhesive is less than 0.10, measured as:
$$\frac{bond strength of cured debondable adhesive}{bond strength of uncured debondable adhesive}$$
wherein the bond strength is measured with ASTM D903.

7. The article of claim 6, wherein the debondable adhesive further comprises a photoinitiator, amine, amine acrylate adduct, tackifier, a solvent, a wax, an antioxidant, and mixtures thereof.

8. The article of claim 6, further comprising a second substrate bonded to the debondable adhesive, wherein the debondable adhesive is sandwiched between the first substrate and the second substrate.

9. The article of claim 8, which is a laminate.

10. A method of debonding an article, wherein the article comprises a substrate having a first surface and a second surface, and a debondable adhesive coated onto the first surface and bonded to the substrate, comprising the steps of:
a) preparing the article; and
b) applying an electron beam or a UV light to the article, whereby the debondable adhesive becomes substantially non-tacky; and
wherein the debondable adhesive has (1) an acrylic oligomer having (i) a viscosity range of at least 300 cps to about 8,000 cps measured by ASTM D4402 at 60° C.; and (ii) at least two acrylate functional groups, and (2) at least one polymer having a solubility parameter range greater than about 8 to less than about 15; and (3) a residual strength ratio of less than about 0.10, measured as:
$$\frac{bond strength of cured debondable adhesive}{bond strength of uncured debondable adhesive}$$
wherein the bond strength is measured with ASTM D903.

11. The method of debonding an article of claim 10, wherein the debondable adhesive further comprises a photoinitiator, amine, amine acrylate adduct, tackifier, a solvent, a wax, an antioxidant, and mixtures thereof.

12. The method of debonding the article of claim 10, wherein the electron beam or the UV light is applied onto the debondable adhesive in step (b).

13. The method of debonding the article of claim 10, wherein the electron beam or the UV light is applied onto the second surface of the substrate in step (b).

14. The method of debonding the article of claim 10, wherein the substrate is a paper, plastic, metal, fiber, wood, film, carpet, glass, rubber, composite, crystal, mineral or foam.

15. The method of debonding the article of claim 10, further including the step (c) agitating the debondable adhesive or the substrate, whereby the debondable adhesive and the substrate separates from each other.

16. A method of debonding a laminate, wherein the laminate comprises a first substrate having a first surface and a second surface, a second substrate having a first surface and a second surface, and a debondable adhesive coated and bonded the first surface of the first substrate and second surface of the second substrate, comprising the steps of:
a. preparing the article;
b. applying an electron beam or a UV light to the laminate;
c. agitating at least one substrate, whereby the at least one substrate separates from the laminate;
wherein the debondable adhesive has (1) an acrylic oligomer having (i) a viscosity range of at least 300 cps to about 8,000 cps measured by ASTM D4402 at 60° C., and (ii) at least two acrylate functional groups; and (2) at least one polymer having a solubility parameter range greater than about 8 to less than about 15; and (3) a residual strength ratio of less than about 0.10, measured as:
$$\frac{bond strength of cured debondable adhesive}{bond strength of uncured debondable adhesive}$$
wherein the bond strength is measured with ASTM D903.

17. The method of debonding a laminate of claim 16, wherein the debondable adhesive further comprises a photoinitiator, amine, amine acrylate adduct, tackifier, a solvent, a wax, an antioxidant, and mixtures thereof.

18. The method of debonding the laminate of claim 16, wherein the first substrate and the second substrate, independently, is a paper, plastic, metal, fiber, wood, film, carpet, glass, rubber, composite, crystal, mineral or foam.

19. The method of debonding the laminate of claim 16, wherein the electron beam or the UV light is applied onto the second surface of the first substrate or the first surface of the second substrate in step (b).
